(19) United States
(12) Patent Application Publication
(10) Pub. No.: US 2010/0100494 A1
(43) Pub. Date: Apr. 22, 2010

(54) DETERMINATION OF PATHS BETWEEN ENTITIES IN A MULTI-RELATIONSHIP SOCIAL NETWORK

(76) Inventors: Ricardo Polo-Malouvier, Levallois-Perret (FR); Bogdan Marinoiu, Bures sur Yvette (FR)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/253,614

(22) Filed: Oct. 17, 2008

(51) Int. Cl. G06Q 10/00

(52) U.S. Cl. 705/319

(57) ABSTRACT

Some aspects include determination of a source entity and a target entity from a plurality of entities, wherein a first one of the plurality of entities is associated with a second one of the plurality of entities by a first type of social relationship and a third one of the plurality of entities is associated with a fourth one of the plurality of entities by a second type of social relationship, and determination of a shortest path through the plurality of entities from the source entity to the target entity.

### BACKGROUND

Modern organizations store vast quantities of electronic information. Much of this information is associated in some manner with one or more people. For example, different systems of an enterprise may variously store personal contact information, management structures, electronic mail communications, project assignments, etc. This data may reflect different types of connections (e.g., contact, manager_managee, project, location, etc.) between members of the enterprise.

Conventional systems do not provide efficient mechanisms to mine the relationship-related knowledge embedded in this data. More specifically, no conventional systems allow for a thorough understanding of the myriad ways in which two people may be related inside an organization. Existing relations between disparate people may therefore be overlooked at the expense of productivity. For example, it is extremely difficult, if not impossible, to identify a sequence of people relating one person to another person, wherein the sequence reflects more than one type of personal relationship.

Systems are desired for improving the determination of paths between related entities in a multi-relationship network.

### BRIEF DESCRIPTION OF THE DRAWINGS

FIG. 1 is a graph illustrating entities associated with one another by different types of relationships according to some embodiments.

FIG. 2 is a flow diagram of a process according to some embodiments.

FIG. 3 is a block diagram of a system according to some embodiments.

FIG. 4 is a tabular representation of a portion of an Entities table according to some embodiments.

FIG. 5 is a tabular representation of a portion of a Relations table according to some embodiments.

FIGS. 6A and 6B comprise a flow diagram of a process according to some embodiments.

FIG. 7 is a view of a search interface according to some embodiments.

FIGS. 8 through 18 comprise tabular representations of a Previous table, a Step table, a UsefulRelations table, and a Current_level variable during the process of FIG. 6A according to some embodiments.

FIGS. 19 through 21 comprise a tabular representation of a UsefulRelations table, a Current variable, and an Output variable during the process of FIG. 6B according to some embodiments.

FIG. 22 is a view of a search interface according to some embodiments.

FIG. 23 is a view of a search interface according to some embodiments.

FIG. 24 is a view of a search interface according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

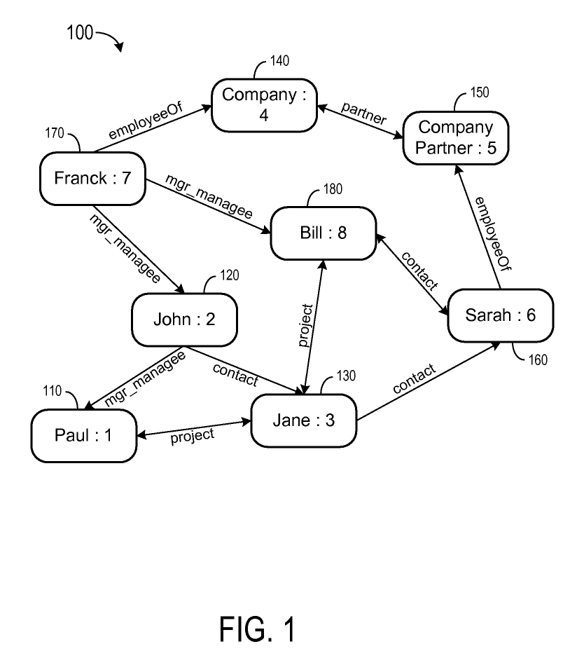

FIG. 1 illustrates a graph of multi-relationship network 100 according to some embodiments. Network 100 may comprise a multi-relationship network of related entities within an organization. Embodiments may encompass any suitable type of organization.

Network 100 consists of nodes 110 through 180, each of which represents an entity. Nodes 110, 120, 130, 160, 170 and 180 represent people, and nodes 140 and 150 represent companies. Embodiments are not limited to these two types of entities.

Each of nodes 110 through 180 is related to at least one other node of network 100. The illustrated arrows indicate the type of relation between two nodes and, if applicable, a “direction” of the relation. The text within each of nodes 110 through 180 is formatted as Entity_Name: Entity_ID for assisting the following description.

In this regard, embodiments are not limited to network 100. Embodiments may be applied to multi-relationship social networks comprising any number of entities, any types of relationships between entities, and multiple relationships between any pair of entities. Moreover, the information provided by the graph of FIG. 1 may be determined from any data sources in any suitable manner that is or becomes known.

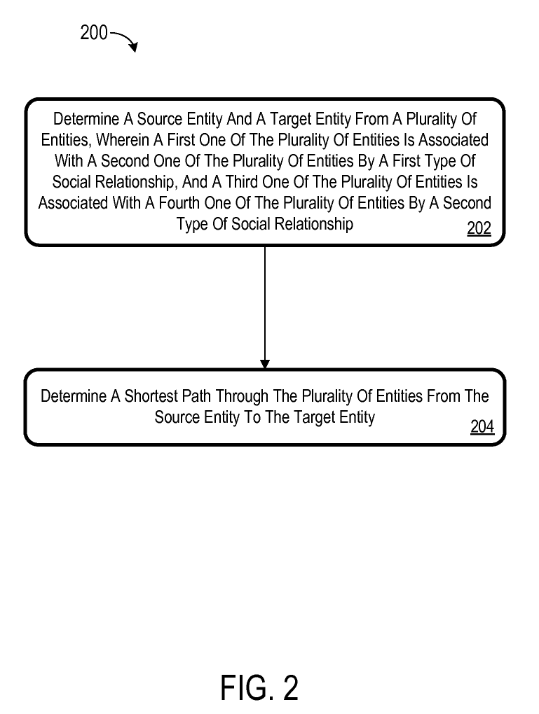

FIG. 2 is a flow diagram of process 200 according to some embodiments. Process 200 may be executed by hardware and embodied in program code stored on a tangible computer-readable medium. Process 200 may be performed in conjunction with network 100, but embodiments are not limited thereto.

Initially, a source entity and a target entity are determined from a plurality of entities at 202. A first one of the plurality of entities is associated with a second one of the plurality of entities by a first type of social relationship. Moreover, a third one of the plurality of entities is associated with a fourth one of the plurality of entities by a second type of social relationship.

Network 100 illustrates a multi-relationship social network as described at 202. For example, network 100 represents a plurality of entities, and a first one of the entities (e.g., Entity Franck) is associated with a second one of the entities (e.g., Entity Bill) by a first type of social relationship (e.g., manager_managee). A third one of the entities (e.g., Entity Jane) is associated with a second one of the entities (e.g., Entity Sarah) by a second type of social relationship (e.g., contact). A source entity and a target entity may therefore be determined from the entities of network 100 at 202.

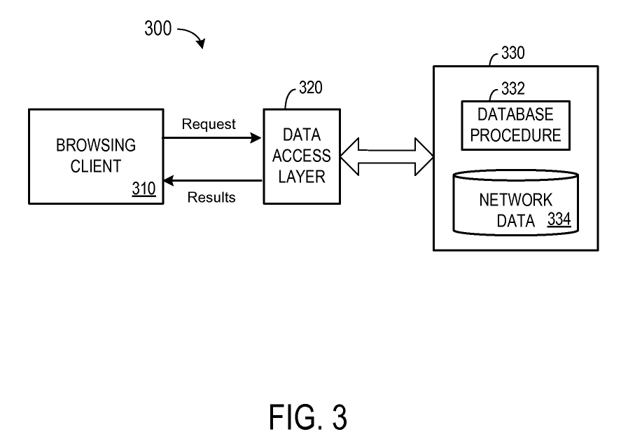

The source entity and the target entity may be specified by a client. System 300 of FIG. 3 is a simple block diagram illustrating an architecture to implement process 200 according to some embodiments. As shown, browsing client 310 may transmit a request specifying a source entity and a target entity to data access layer 320. Browsing client 310 may comprise any suitable device, such as a desktop computer, a laptop computer, a personal digital assistant, a tablet PC, and a smartphone. Browsing client 310 may execute program code of a rich client application, an applet in a Web browser, or any other application to perform the processes attributed thereto herein.

Data access layer 320 may provide security functions (authentication, etc.) and simplified access to data stored in database system 330. For example, data access layer 320 may expose a class of data access methods that directly reference a corresponding set of stored database procedures such as database procedure 332. The procedures are called from a method inside the class, and the method returns an object of network data 334 to client 310 containing the requested values.

More particularly, browsing client 310 may pass the source entity and the target entity as parameters to a method exposed by data access layer 320. The method calls database procedure 332 and passes the source entity and the target entity thereto. Database procedure 332 may then perform the determination at 202. Database procedure 332 may comprise executable program code according to some embodiments.

Next, a shortest path from the source entity to the target entity, and through the plurality of entities, is determined at 204. Continuing with the above example, database procedure 332 may perform the determination at 204 based on network data 334.

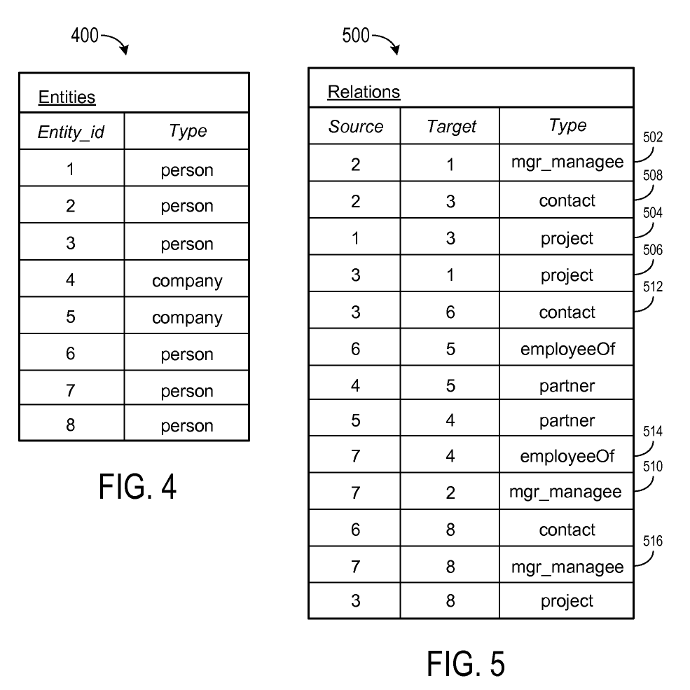

Network data 334 may comprise any number of data structures including data specifying the relationships of a multi-relationship network. FIGS. 4 and 5 are tabular representations of tables that are stored in network data 334 and include data specifying the relationships of network 100 according to some embodiments.

Entities table 400 includes a column Entity_id and a column Type. The numbers in each row of column Entity_id correspond to the entities represented by nodes 110 through 180 of network 100. For each such entity, column Type indicates a type of the entity. Although Entities table 400 illustrates only “person” and “company” entity types, embodiments are not limited thereto.

Relations table 500 includes columns Source, Target, and Type. Each row of Relations table 500 is associated with a single relationship illustrated in FIG. 1. Each relationship is therefore associated with a source entity (i.e., identified in corresponding column Source), a target entity (i.e., identified in corresponding column Target), and a relationship type. Embodiments are not limited to the relationship types of table 500.

The stored values of Relations table 500 may be determined in any suitable manner that is or becomes known. For example, information from several data sources may be analyzed to determine relationships between pairs of entities and to assign types to the relationships. Each identified relationship may be represented by a row of Relations table 500. Network 100 of FIG. 1 may be graphed based on the data of Relations table 500.

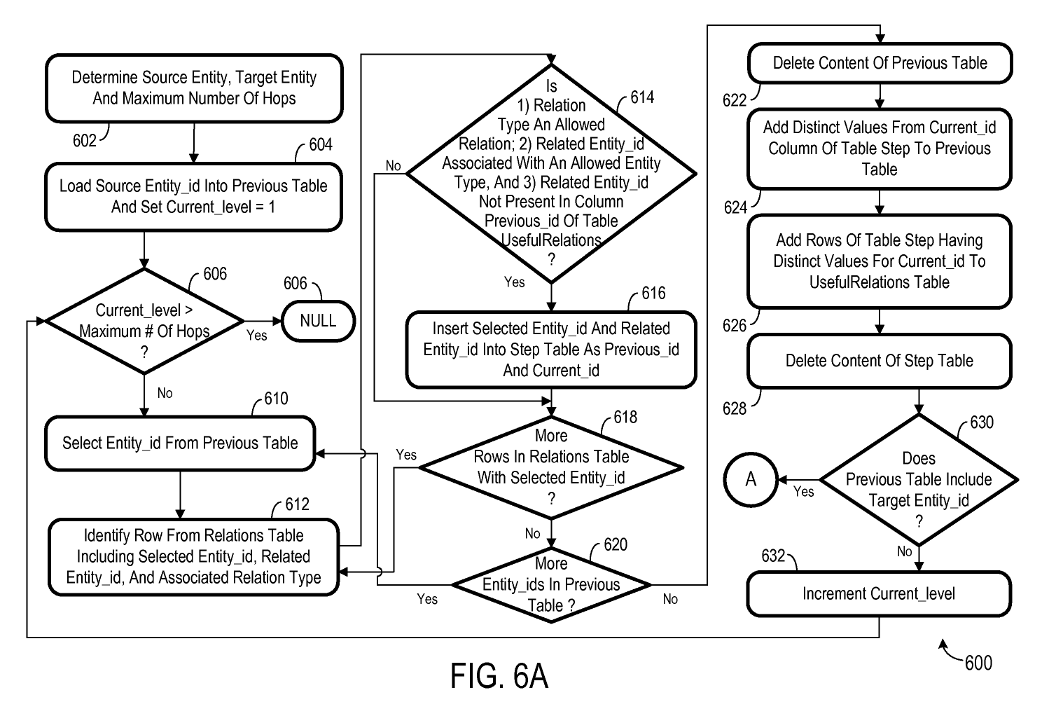

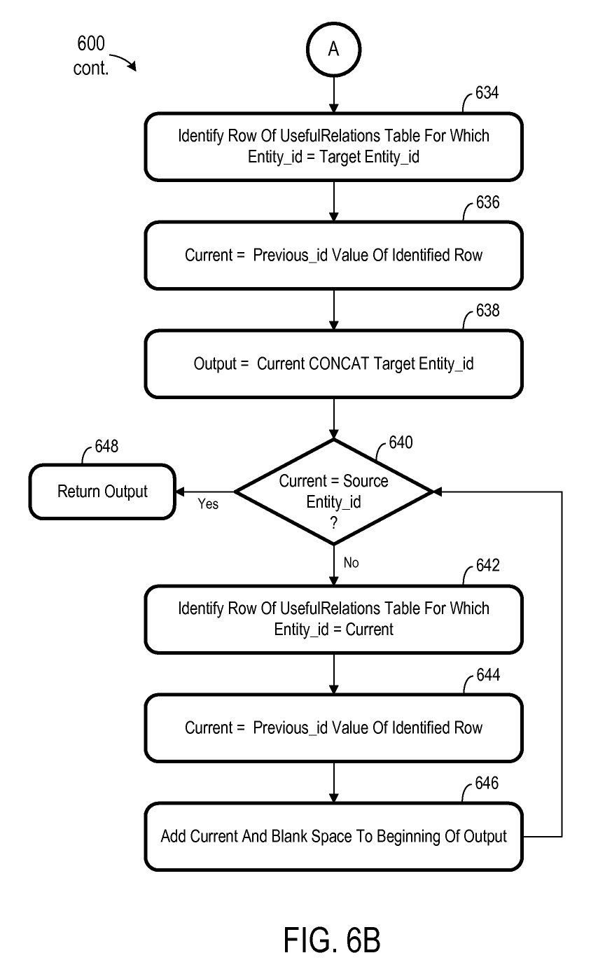

FIGS. 6A and 6B illustrate process 600 according to some embodiments. Process 600 may comprise an implementation of process 200. Process 600 may be embodied in program code of database procedure 332 and performed by execution thereof.

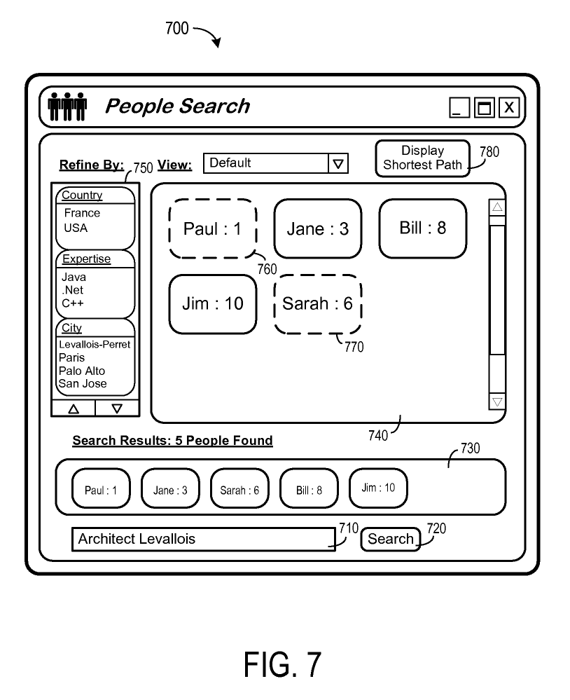

A source entity, target entity and a maximum number of hops are determined at 602. The source entity, target entity and maximum number of hops may be determined based on user input according to some embodiments. FIG. 7 illustrates user interface 700 for specifying the source entity, target entity and maximum number of hops according to some embodiments. User interface 700 may be displayed by browsing client 310 of system 300. As described above, browsing client 310 may provide interface 700 through execution of program code of a rich client application, an applet in a Web browser, or any other suitable application.

User interface 700 includes input field 710 and Search button 720. Selection of Search button 720 causes issuance of a query based on the terms present in field 710. According to some embodiments, the query is transmitted to data access layer 320 and passed on to database system 330. Database system 330 processes the query and determines search results based on information stored in network data 334. The results are returned to browsing client 310 through data access layer 320.

As shown, search terms have been entered into input field 710 and Search button 720 has been selected. According to the present embodiment, the search terms are intended to identify one or more people represented in data network 334. Results window 730 and browsing window 740 show the results of the search. Each search result identifies a person and may be associated with metadata (i.e., facets) related to the person.

Browsing window 740 may provide several types of views according to some embodiments. For example, browsing window 740 may provide for display of a graph such as shown in FIG. 1 and including one or more of the search results shown in window 730. Navigation window 750 may change dynamically based on the metadata associated with the search results that are currently displayed in browsing window 740. Selection of one or more facets of navigation window 750 may filter the results displayed in browsing window 740 based on the selected facets.

The current example depicts selection of search result 760 and search result 770 within browsing window 740. Search result 760 and search result 770 each correspond to a respective entity. It will be assumed that search result 760 is the first selected result and thereby corresponds to the source entity of 602, while later-selected search result 770 corresponds to the target entity of 602. Accordingly, subsequent selection of button 780 initiates a call to a method to determine a shortest path between the source entity and the target entity. If only one search result of browsing window 740 is selected when button 780 is selected, it may be assumed that the search result corresponds to the target entity and that the source entity is a user of browsing client 310.

The call is received by data access layer 320 and the corresponding method invokes database procedure 332. The call specifies the source entity (e.g., entity “1”) and the target entity (e.g., entity “6”), and may also specify a maximum number of hops. The maximum number of hops may be user-specified, hard-coded into browsing client 310, or hard-coded into database procedure 332. For purposes of the present example, it will be assumed that the maximum number of hops is 5. Having thereby determined the source entity, the target entity, and the maximum number of hops, database procedure 332 may be further executed to perform the remaining elements of process 604.

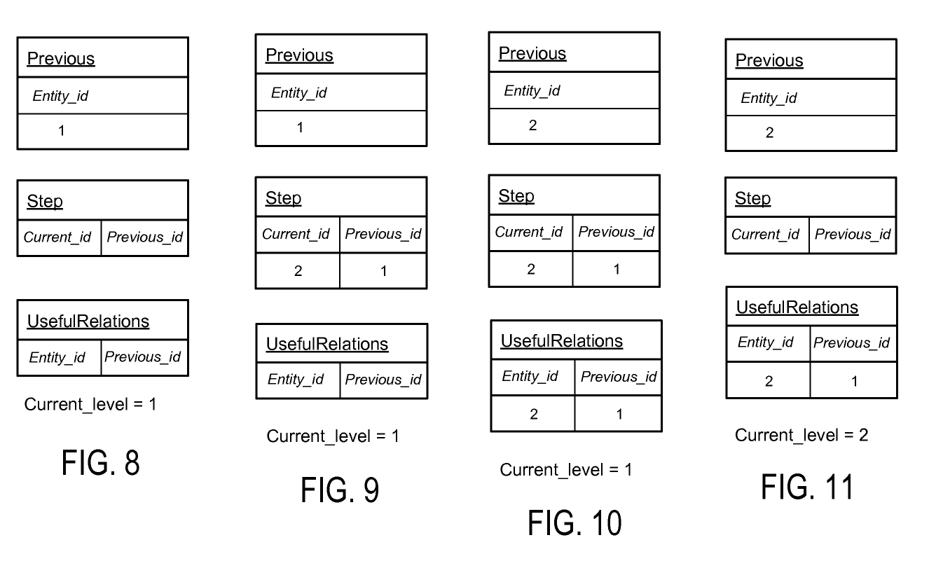

The Entity_id of the source entity is loaded into a Previous table at 604. Also at 604, the value 1 is assigned to a variable Current_level. FIG. 8 depicts the Previous table and the variable Current_level after 604 according to the current example. FIG. 8 also depicts a Step table and a UsefulRelations table, both of which are empty after 604 and which will be utilized during process 600. The Previous, Step and UsefulRelations tables may be stored in random access memory of database system 330 during process 600.

At 606, it is determined whether the variable Current_level is greater than the maximum number of hops. If so, flow proceeds to 608 to return a NULL value indicating that no path between the source entity and the target entity and consisting of less than the maximum number of hops could be determined. In the present instance, the variable Current_level (i.e., 1) is not greater than the maximum number of hops (i.e., 5) and flow proceeds to 610.

An Entity_id is selected from the Previous table at 610. Entity_id “1” is selected at 610 because the Previous table includes only Entity_id “1”. Next, at 612, a row of a Relations table is identified. The Relations table specifies relationships between pairs of entities and also specifies the types of the relationships. The identified row includes the Entity_id selected at 610, a related Entity_id, and an associated relation type. Using Relations table 500 as an example, row 502 is identified because the corresponding value of column Target is equal to “1” (i.e., the selected Entity_id). The related Entity_id and associated relation type are “2” and “mgr_managee”, respectively.

The elements of the identified row are subject to several evaluations at 614. First, it is determined whether the relation type of the row is an “allowed” relation type. Database procedure 332 may maintain or may be passed a table specifying types of relations that may be considered when determining a path from the source entity to target entity. For the present example it will be assumed that the allowed relation types are “mgr/managee” and “contact”. Accordingly, the presently-identified row satisfies the first evaluation of 614.

It is then determined whether the related Entity_id of the identified row is an “allowed” entity type. Similarly as described with respect to allowed relation types, database procedure 332 may maintain or may be passed a table specifying types of entities that may be considered when determining a path from the source entity to target entity. Only “person” type entities will be allowed in the present example. The current related Entity_id of “2” corresponds, as shown in Entities table 400, to a “person” entity type and therefore the second evaluation of 614 is satisfied.

Lastly, it is determined whether the related Entity_id of the identified row is not present in column Previous_id of the UsefulRelations table. The column Previous_id is empty at this point of the example, therefore the related Entity_id of the identified row is not present in this column.

If all the evaluations of 614 are satisfied, the selected Entity_id is inserted into column Previous_id of the Step table and the related Entity_id is inserted into column Current_id of the Step table. FIG. 9 shows the Previous table, the Step table, and the UsefulRelations table after the operation as described above.

At 618, it is determined whether additional rows of the Relations table include the currently-selected Entity_Id. In the present example, the selected Entity_id (i.e., “1”) is present in row 504 of Relations table 500. Flow therefore returns to 612 to identify related Entity_id “3” in column Target of row 504 and associated relation type “project”. Next, it is determined at 614 that the relation type “project” of the identified row is not an allowed relation, and flow proceeds to 618 once more.

Again at 618, it is determined that the selected Entity_id (i.e., “1”) is present in row 506 of Relations table 500. Flow therefore returns to 612 to identify related Entity_id “3” in column Source of row 506 and associated relation type “project”. It is again determined at 614 that the relation type “project” of the identified row is not an allowed relation, and flow returns to 618. At this point, it is determined that no additional rows of the Relations table include the currently-selected Entity_Id (i.e., “1”).

Next, at 620, it is determined whether the Previous table includes more Entity_ids. Flow continues from 620 to 622 because the Previous table of FIG. 9 only includes the one previously-selected entity_id. The content of the Previous table is deleted at 622, and distinct values from the column current_id of the Step table are added to the Previous table at 624. Moreover, each row of the Step table having a distinct value in the column current_id is added to the UsefulRelations table at 626.

The column current_id of the Step table as shown in FIG. 9 includes only one distinct value (i.e., “2”). Accordingly, the value “2” is added to the Previous table at 624 after the contents of the Previous table are deleted at 622. The row of the Step table including the distinct value (i.e., “2”) is then added to the UsefulRelations table at 626. FIG. 10 illustrates the contents of the Previous, Step and UsefulRelations tables after 626 according to the above example.

The content of the Step table is deleted at 628 and, at 630, it is determined whether the Previous table includes the Entity_id of the target entity (i.e., “6”). Since the Previous table does not include the Entity_id of the target entity, the variable Current_level is incremented at 632 and flow returns to 606. In this regard, FIG. 11 illustrates the deletion of the contents of the Step table at 628 and the incrementing of the variable Current_level at 632.

At 606, it is again determined whether the variable Current_level is greater than the maximum number of hops. Flow proceeds to 610 because the variable Current_level (i.e., 2) is still not greater than the maximum number of hops (i.e., 5). Sole Entity_id “2” is selected from the Previous table at 610. Next, at 612, a row of Relations table 500 is identified which includes the Entity_id selected at 610 (i.e., “2”), a related Entity_id, and an associated relation type. Row 502 is identified because the corresponding value of column Source is equal to “2” (i.e., the Entity_id selected at 610). The related Entity_id and associated relation type are “1” and “mgr managee”, respectively.

Next, at 614, it is determined that the relation type of the identified row (i.e., “mgr/managee”) is an “allowed” relation type. It is then determined, based on Entities table 400, that the related Entity_id (i.e., “1”) of the identified row is an “allowed” entity type (i.e., “person”). Lastly, it is determined that the related Entity_id of the identified row (i.e., “1”) is present in column Previous_id of the UsefulRelations table (see FIG. 11).

Since the determination at 614 is negative, flow continues to 618 to determine if any other another rows of Relations table 500 include the selected Entity_id (i.e., “2”). Row 508 is identified because the corresponding value of column Source is equal to “2” (i.e., the Entity_id selected at 610). The related Entity_id and associated relation type of row 508 are “3” and “contact”, respectively.

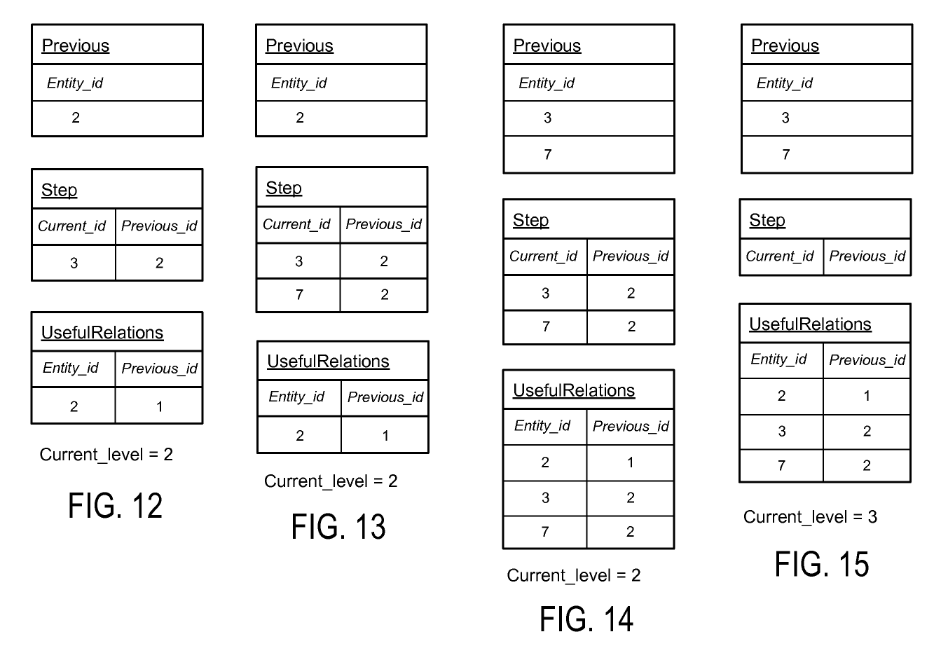

The related Entity_id and associated relation type of row 508 satisfy the evaluations at 614, and therefore, at 616, the selected Entity_id (i.e., “2”) is inserted into column Previous_id of the Step table and the related Entity_id (i.e., “3”) is inserted into column Current_id of the Step table. FIG. 12 shows the Step table modified as described above.

Again returning to 618, row 510 is identified because the corresponding value of column Target is equal to the selected Entity_id (i.e., “2”). As shown in FIG. 5, the related Entity_id and associated relation type of row 510 are “7” and “mgr/managee”, respectively. Since the related Entity_id and associated relation type of row 508 satisfy the evaluations at 614, the selected Entity_id (i.e., “2”) is inserted into column Previous_id of the Step table and the related Entity_id (i.e., “7”) is inserted into column Current_id of the Step table. FIG. 13 illustrates this modification to the Step table.

Since no more rows in Relations table 500 include the selected Entity_Id and the Previous table does not include any more Entity_Ids, flow continues from 616 through 618 and 620 to 622. The content of the Previous table is deleted at 622, and distinct values from the column current_id of the Step table are added to the Previous table at 624. Each row of the Step table having a distinct value in the column current_id is then added to the UsefulRelations table at 626.

Therefore, the two distinct values of the column current_id of the Step table of FIG. 13 are added to the Previous table at 624 after the contents of the Previous table are deleted at 622. The rows of the Step table including the distinct values are then added to the UsefulRelations table at 626. FIG. 14 illustrates the contents of the Previous, Step and UsefulRelations tables after 626 in the present example.

The content of the Step table is deleted at 628 and it is determined whether the Previous table includes the Entity_id of the target entity (i.e., “6”) at 628. The Previous table does not include the Entity_id of the target entity, so the variable Current_level is incremented at 632 and flow returns again to 606. FIG. 15 shows the contents of the Previous, Step and UsefulRelations tables and the value of the Current_level variable after 632.

Flow proceeds from 606 to 610 in the present example because the variable Current_level (i.e., 3) is not greater than the maximum number of hops (i.e., 5). At 610, a first Entity_id “3” is selected from the Previous table. Next, at 612, a row of Relations table 500 is identified which includes the selected Entity_id (i.e., “3”). Row 508 is initially identified because the corresponding value of column Target is equal to “3”. The related Entity_id and associated relation type are “2” and “contact”, respectively.

At 614, it is determined that the related Entity_id (i.e., “2”) is present in column Previous_id of the UsefulRelations table (see FIG. 15). Flow then cycles through 618, 612, 614, 618, 612, 614 and 618 to identify and similarly reject rows 504 (e.g., related Entity_id “1” is present in column Previous_id of the UsefulRelations table) and 506 (e.g., related Entity_id “1” is present in column Previous_id of the UsefulRelations table).

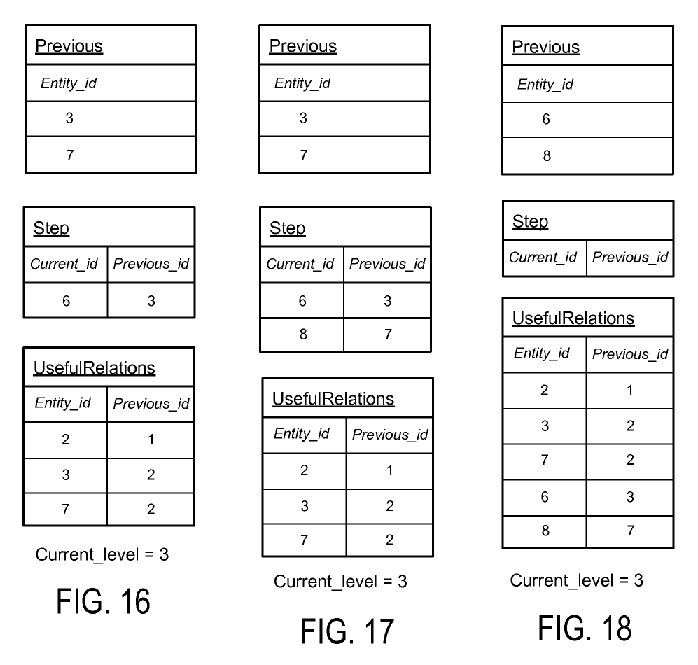

Flow returns to 612 because the value of column Source of row 512 is equal to “3”. The related Entity_id and relation type associated with row 512 are “6” and “contact”, respectively. The following determination at 614 is positive, so, at 616, the selected Entity_id (i.e., “3”) is inserted into column Previous_id of the Step table and the related Entity_id (i.e., “6”) is inserted into column Current_id of the Step table. FIG. 16 shows the Step table modified at 616 as described above.

At 618, it is determined that no more rows of Relations table 500 include the currently-selected Entity_Id (i.e., “3”). It is then determined at 620 that the Previous table includes another Entity_Id. Accordingly, and returning to 610, Entity_id “7” is selected from the Previous table. Next, at 612, row 514 of Relations table 500 is identified as including the selected Entity_id (i.e., “7”), as well as the related Entity_id “4” and associated relation type are “employeeOf”.

Next, at 614, it is determined that the relation type “employeeOf” is not an allowed relation type. Flow then cycles through 618, 612, 614 and 618 to identify and reject row 510 (e.g., related Entity_id “2” is present in column Previous_id of the UsefulRelations table of FIG. 16). Flow then returns to 612 because the value of column Source of row 516 is equal to “7”. The related Entity_id and relation type associated with row 512 are “6” and “contact”, respectively. The following determination at 614 is positive, so, at 616, the selected Entity_id (i.e., “7”) is inserted into column Previous_id of the Step table and the related Entity_id (i.e., “8”) is inserted into column Current_id of the Step table. FIG. 17 shows the Step table modified as described above.

Since no more rows in Relations table 500 include the selected Entity_Id (i.e., “7”) and the Previous table does not include any more Entity_Ids, flow continues from 616 to 622, at which the content of the Previous table is deleted. Next, at 624, distinct values from the column current_id of the Step table are added to the Previous table. Each row of the Step table having a distinct value in the column current_id is then added to the UsefulRelations table at 626.

The two distinct values (i.e., “6” and “8”) of the column current_id of the Step table of FIG. 17 are added to the Previous table at 624 after the contents of the Previous table are deleted at 622. The two rows of the Step table including the distinct values are then added to the UsefulRelations table at 626. FIG. 18 illustrates the contents of the Previous, Step and UsefulRelations tables after 626 according to the present example.

The content of the Step table is then deleted at 628 and it is determined whether the Previous table includes the Entity_id of the target entity (i.e., “6”) at 628. Since the Previous table now includes the Entity_id of the target entity, flow proceeds to 634 of FIG. 6B.

A row of the UsefulRelations table for which column Entity_Id includes the Entity_id of the target entity (i.e., “6”) is identified at 634. Next, at 636, a variable Current is initialized with the value of column Previous_Id of the identified row. A variable Output is then defined at 638 as the value of variable Current concatenated with the target Entity_id.

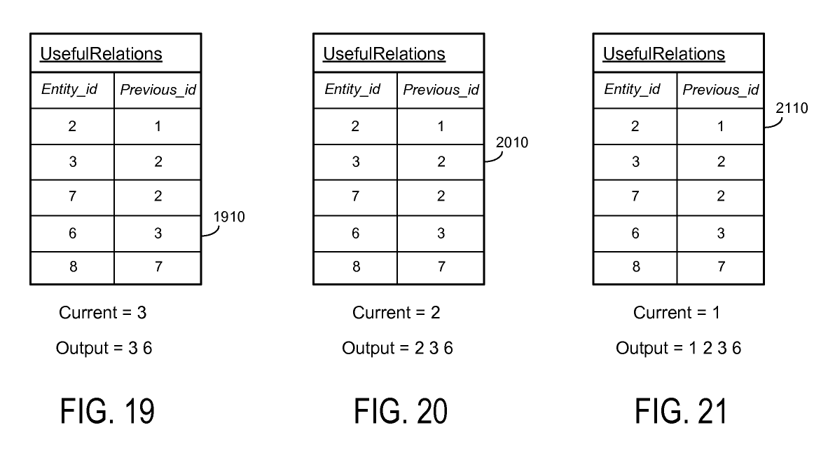

With reference to FIG. 19, row 1910 is identified at 634 because a value of column Entity_id is equal to the target entity (i.e., “6”). Accordingly, variable Current is shown in FIG. 19 as being assigned the value of column Previous_id of row 1910 (i.e., “3”). Lastly, variable Output has been assigned the value of Current (i.e., “3”) concatenated with “6” (i.e., the target Entity_id).

At 640, it is determined whether the value of Current equals the source Entity_Id. Flow continues to 642 because the source Entity_Id is “1” and the value of variable Current is “3”. A row of the UsefulRelations table for which column Entity_Id equals the value of variable Current is identified at 642. Next, at 644, variable Current is assigned the value of column Previous_Id of the identified row. The value of variable Current and a blank space are then added to the beginning of variable Output at 646.

Row 2010 of FIG. 20 is identified at 642 because a value of column Entity_id is equal to the value of variable Current (i.e., “3”). Variable Current is also shown in FIG. 20 as being assigned the value of column Previous_id of row 2010 (i.e., “2”) at 644. The value of Current (i.e., “2”) and a blank space are also shown as added to the beginning of variable Output at 646.

Flow returns to 640 and continues to 642 because the source Entity_Id is “1” and the value of variable Current is “2”. Row 2110 of the UsefulRelations table is identified at 642 because a value of column Entity_Id equals the value of variable Current (i.e., “2”. Variable Current is then assigned the value of column Previous_Id (i.e., “1”) of row 2110 at 644. The value of variable Current (i.e., “1”) and a blank space are then added to the beginning of variable Output at 646 and as shown in FIG. 21.

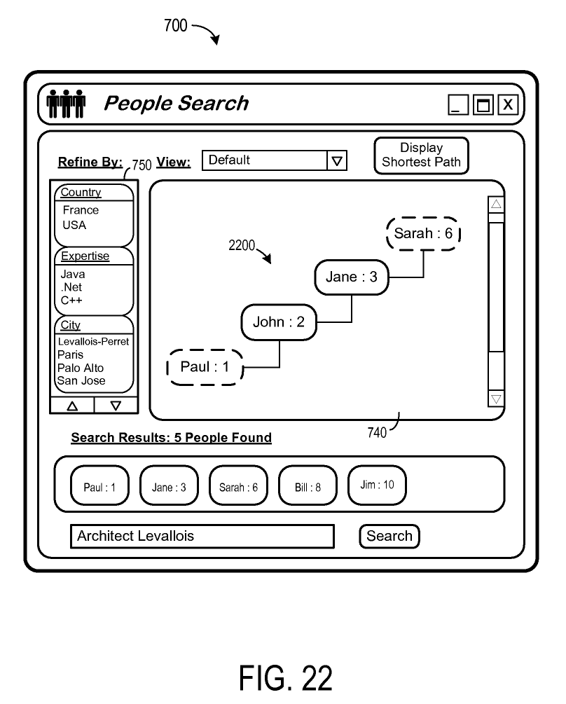

Flow returns from 646 to 640, where it is determined that the value of variable Current is equal to the source Entity_Id (i.e., “1”). Flow therefore proceeds to 648, where the value of variable Output is returned. The variable Output represents the shortest path between the source entity and the target entity, taking into account allowed entities and allowed relation types. The value of variable Output may be returned by database procedure 332 to browsing client 310 via data access layer 320. Browsing client 310 may use the value of variable Output to construct a view of the path as shown in FIG. 22.

The returned Output according to the present example is “1 2 3 6”, therefore browsing window 740 of FIG. 22 shows path 2200 comprising a graphical view interconnecting entities associated with Entity_ids “1”, “2”, “3” and “6”. Browsing client 310 may build path 2200 by querying database system 330 for data and/or metadata relating to each of Entity_ids “1”, “2”, “3” and “6”. According to some embodiments, navigation window 750 shows only facets associated with the entities of path 2200. Of course, a path between Entity_ids “1”, “2”, “3” and “6” may be depicted in any number of ways similar to or different from that shown in FIG. 22. In some embodiments, the interconnection between two entities of path 2200 may depict the type of relation which associates the two entities.

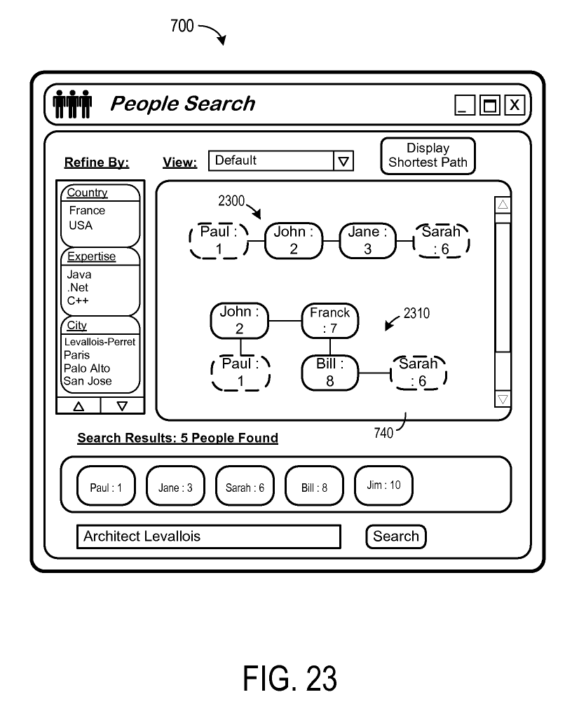

FIG. 23 is a view of interface 700 showing two paths from the source entity to the target entity based on network 100 of FIG. 1, and based on the allowed relation types and allowed entities described above. Both of paths 2300 and 2310 exhibit less than the specified maximum number of hops. Path 2300 may be determined as described above with respect to process 600. Path 2310 may be determined in a similar or any other suitable manner.

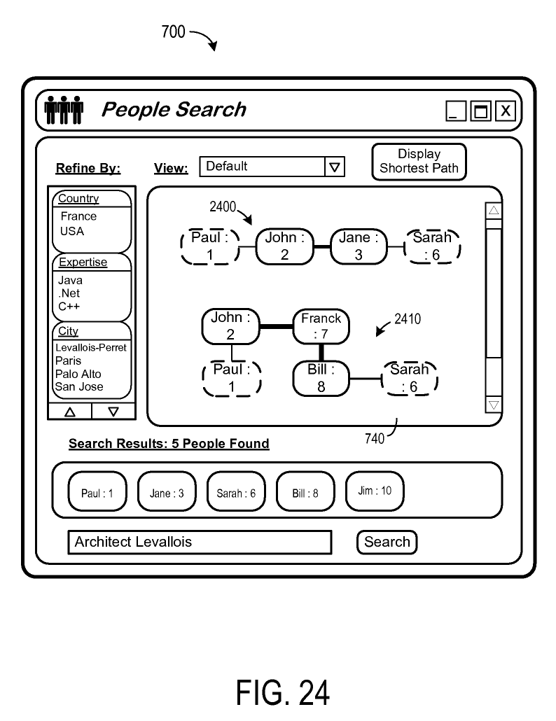

Browsing window 740 of FIG. 24 shows paths 2400 and 2410 according to some embodiments. Each relationship reflected in paths 2400 and 2410 is associated with a weighting (e.g., in a column Weighting of Relations table 500). The weightings are reflected by the thickness of the lines connecting the entities. According to some embodiments, the weightings are taken into account to determine which one of paths 2400 and 2410 to display in browsing window 740. For example, it may be determined that path 2410 is “effectively” shorter than path 2400 due to the associated weightings of path 2410, even though the number of hops exhibited by path 2410 (i.e., 4) is greater than the number of hops exhibited by path 2400 (i.e., 3).

The embodiments described herein are solely for the purpose of illustration. Those in the art will recognize that other embodiments may be practiced with modifications and alterations limited only by the claims.

What is claimed is:

1. A method comprising:
determining a source entity and a target entity from a plurality of entities, wherein a first one of the plurality of entities is associated with a second one of the plurality of entities by a first type of social relationship and a third one of the plurality of entities is associated with a fourth one of the plurality of entities by a second type of social relationship; and
determining a shortest path through the plurality of entities from the source entity to the target entity.

2. A method according to claim 1,
wherein each of the plurality of entities is a person.

3. A method according to claim 2, wherein the first type of social relationship is a supervisory relationship and the second type of social relationship is a contact relationship.

4. A method according to claim 1, further comprising:
determining a maximum path length,
wherein determining the shortest path comprises determining that no path through the plurality of entities from the source entity to the target entity is associated with a length equal to or less than the maximum path length.

5. A method according to claim 1, wherein determining the shortest path comprises:
identifying a first set of the plurality of entities, each entity of the first set being associated with the source entity by at least one social relationship;
identifying a second set of the plurality of entities, each entity of the second set being associated with at least one of the entities of the first set by at least one social relationship; and
identifying a third set of the plurality of entities, each entity of the third set being associated with the target entity by at least one social relationship.

6. A method according to claim 1, wherein determining the shortest path comprises:
determining a plurality of paths through the plurality of entities from the source entity to the target entity, each of the plurality of paths comprising a respective set of entities; and
determining the shortest path of the plurality of paths based on weightings of social relationships between the entities of each respective set of entities.

7. A computer-readable medium having stored thereon program code, the program code executable by a computer to:
determine a source entity and a target entity from a plurality of entities, wherein a first one of the plurality of entities is associated with a second one of the plurality of entities by a first type of social relationship and a third one of the plurality of entities is associated with a fourth one of the plurality of entities by a second type of social relationship; and
determine a shortest path through the plurality of entities from the source entity to the target entity.

8. A medium according to claim 7,
wherein each of the plurality of entities is a person.

9. A medium according to claim 8, wherein the first type of social relationship is a supervisory relationship and the second type of social relationship is a contact relationship.

10. A medium according to claim 7, the program code further executable by a computer to:
determine a maximum path length,
wherein determination of the shortest path comprises determination that no path through the plurality of entities from the source entity to the target entity is associated with a length equal to or less than the maximum path length.

11. A medium according to claim 7, wherein determination of the shortest path comprises:
identification of a first set of the plurality of entities, each entity of the first set being associated with the source entity by at least one social relationship;
identification of a second set of the plurality of entities, each entity of the second set being associated with at least one of the entities of the first set by at least one social relationship; and
identification of a third set of the plurality of entities, each entity of the third set being associated with the target entity by at least one social relationship.

12. A medium according to claim 7, wherein determination of the shortest path comprises:
determination of a plurality of paths through the plurality of entities from the source entity to the target entity, each of the plurality of paths comprising a respective set of entities; and
determination of the shortest path of the plurality of paths based on weightings of social relationships between the entities of each respective set of entities.

13. A system comprising:
a data repository associating a first one of a plurality of entities with a second one of the plurality of entities by a first type of social relationship and associating a third one of the plurality of entities with a fourth one of the plurality of entities by a second type of social relationship; and
a database procedure to determine a shortest path through the plurality of entities from a source entity of the plurality of entities to a target entity of the plurality of entities.

14. A system according to claim 13,
wherein each of the plurality of entities is a person.

15. A system according to claim 14, wherein the first type of social relationship is a supervisory relationship and the second type of social relationship is a contact relationship.

16. A system according to claim 13, the database procedure further to:
determine a maximum path length,
wherein determination of the shortest path comprises determination that no path through the plurality of entities from the source entity to the target entity is associated with a length equal to or less than the maximum path length.

17. A system according to claim 13, wherein determination of the shortest path comprises:
identification of a first set of the plurality of entities, each entity of the first set being associated with the source entity by at least one social relationship;
identification of a second set of the plurality of entities, each entity of the second set being associated with at least one of the entities of the first set by at least one social relationship; and
identification of a third set of the plurality of entities, each entity of the third set being associated with the target entity by at least one social relationship.

18. A system according to claim 13, wherein determination of the shortest path comprises:
determination of a plurality of paths through the plurality of entities from the source entity to the target entity, each of the plurality of paths comprising a respective set of entities; and
determination of the shortest path of the plurality of paths based on weightings of social relationships between the entities of each respective set of entities.
